(19) United States
(12) Patent Application Publication
(10) Pub. No.: US 2026/0356714 A1
(43) Pub. Date: Nov. 12, 2026

(54) SHARED WATER PURIFICATION SYSTEM

(71) Applicant: LG ELECTRONICS INC., Seoul (KR)

(72) Inventors: Jongwoo PARK, Seoul (KR); Myoung Hoon LEE, Seoul (KR); Jongho PARK, Seoul (KR); Ho Seon CHOI, Seoul (KR)

(21) Appl. No.: 19/134,350

(22) PCT Filed: Feb. 14, 2023
(86) PCT No.: PCT/KR2023/002155

§ 371 Date: May 30, 2025

(30) Foreign Application Priority Data
Dec. 7, 2022 (KR) 10-2022-0169707

(51) Int. Cl. C02F 9/00; C02F 1/00; C02F 1/02; C02F 1/44; C02F 1/467

(52) U.S. Cl. CPC C02F 9/00; C02F 1/003; C02F 1/02; C02F 1/444; C02F 1/467; C02F 2201/005; C02F 2301/043; C02F 2303/04; C02F 2303/16; C02F 2307/10; C02F 2307/12

(57) ABSTRACT

A shared water purification system according to one embodiment comprises: a first pipe through which water introduced from the outside flows; a first three-way valve disposed in the first pipe; a bypass pipe having one end connected to the first three-way valve and the other end connected to the first pipe; a heater disposed in the bypass pipe; a filter disposed at a position past the water output point of the bypass pipe in the flow direction of the water in the first pipe; and a supply pipe which is connected to the first pipe and supplies the water that has passed through the filter to the home appliance. When the shared water purification system is operated in sterilization mode, the water introduced into the first pipe passes through the bypass pipe and is heated in the heater to flow in the supply pipe.

### TECHNICAL FIELD

The present invention relates to a shared water purification system, and more specifically, to a shared water purification system having a configuration capable of effectively sterilizing tubings.

### BACKGROUND ART

The matters described in this subsection are intended to merely provide background information regarding the present invention, and, however, would not constitute prior art.

A water purifier is an apparatus that filters raw water to remove impurities. The water purifier removes suspended solids or harmful substances contained in tap water using a filter, and purifies and discharges the desired amount of water according to the user's operation. Recent models of water purifiers can dispense not only purified water but also hot and cold water, are compact in size, and can be installed in various environments.

Within the water purifier, there are provided tubings through which water flows, and in which a filter, a valve, and the like are installed. However, if the water purifier is used for a long period of time, bacteria and microorganisms may propagate in the tubings, filters, valves, or the like. Consequently, the interior of the water purifier must be cleaned regularly.

In this regard, Republic of Korea Patent Registration No. 10-2411725 has been disclosed.

Conventional technologies are related to water purifiers whose filter is sterilized using a pump and steam in the reverse direction, or using hot water.

However, conventional technologies fail to sterilize all of the water outlet tubings of the water purifier, and thus the problem still remains in that the bacteria and microorganisms continue to propagate in the tubings not subjected to the sterilization.

The water purifier may be disposed, for example, in a kitchen sink cabinet, and be connected with a home appliance requiring a supply of potable water for a user and with a faucet discharging cooking water for cooking food.

This kind of water purifier can supply purified water to both the home appliance requiring drinking water and the faucet discharging cooking water, and, hereinafter, is referred to as a shared water purification system.

The shared water purification system may have tubings disposed complicatedly therein to connect these appliance and faucet to the city water. Therefore, there is a need to effectively sterilize these tubings. Additionally, there is a need to effectively sterilize a filter disposed in the shared water purification system.

Further, there is a need to conceive a configuration capable of simultaneously sterilizing tubings in the shared water purification system, which are connected to a plurality of home appliances and a faucet, to reduce the sterilization progress time.

Meanwhile, there is a need to conceive a configuration capable of individually and sequentially sterilize tubings in the shared water purification system, which are connected to a plurality of home appliances and a faucet, to increase the sterilization effect.

### DISCLOSURE

### Technical Problem

It is an object of the present invention to provide a shared water purification system having a configuration capable of effectively sterilizing a tubing and a filter with the use of hot water.

Also, it is an object of the present invention to provide a shared water purification system having a configuration capable of simultaneously sterilizing tubings connected to a plurality of home appliances and a faucet.

Also, it is an object of the present invention to provide a shared water purification system having a configuration capable of individually and sequentially sterilizing a plurality of home appliances and a faucet.

The purposes of the present invention are not limited to the purposes mentioned above, and other purposes and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

### Technical Solution

One embodiment of a shared water purification system may include a first three-way valve disposed in the first tubing, a second three-way valve disposed in the supply tubing, a heater disposed in the bypass tubing, a cooking water tubing supplying water which has passed through the filter as cooking water, wherein when operating in a sterilization mode, water flowing into the first tubing may pass through the bypass tubing while being heated in the heater, and then sterilize the supply tubing and the cooking water tubing.

Thereby, the complex tubings provided in the shared water purification system can be easily sterilized using simple devices such as the heater and the three-way valve.

Water flowing into the first tubing may pass through the bypass tubing while being heated in the heater, and then flow through the supply tubing and the cooking water tubing simultaneously, thereby sterilizing these tubings simultaneously.

Consequently, it is possible to shorten the time required to sterilize the plurality of tubings provided in the shared water purification system.

Water flowing into the first tubing may pass through the bypass tubing while being heated in the heater, and then flow through the supply tubing and the cooking water tubing at different times, thereby sterilizing each tubing sequentially.

Consequently, it is possible to sterilize each tubing provided in the shared water purification system sufficiently and thoroughly.

A shared water purification system according to one embodiment may include a first tubing through which water flowing in from an outside flows, a first three-way valve disposed in the first tubing, a bypass tubing connected at one end to the first three-way valve and at another end to the first tubing, a heater disposed in the bypass tubing, a filter disposed at a location in the first tubing past a water output point of the bypass tubing in a flow direction of water, and a supply tubing connected to the first tubing and supplying water which has passed through the filter to a home appliance, wherein when the shared water purification system operates in a sterilization mode, water flowing into the first tubing may pass through the bypass tubing while being heated in the heater, and then flow through the supply tubing.

The shared water purification system may include a cooking water tubing connected to the first tubing and supplying water which has passed through the filter as cooking water, wherein when the shared water purification system operates in a sterilization mode, water flowing into the first tubing may pass through the bypass tubing while being heated in the heater, and then flow through the cooking water tubing.

The shared water purification system may include a cooking water valve disposed in the cooking water tubing and opening or closing the cooking water tubing.

The shared water purification system may include a second three-way valve disposed in the supply tubing, a second tubing coupled at one end to the second three-way valve, and a drain tubing connected to the second tubing and discharging water flowing through the second tubing to an outside.

When the shared water purification system operates in a sterilization mode, water which has flowed into the supply tubing may flow sequentially through the second tubing and the drain tubing, and then be discharged to an outside.

When the shared water purification system operates in a sterilization mode, water flowing into the first tubing may pass through the bypass tubing while being heated in the heater, and then flow through the supply tubing and the cooking water tubing simultaneously.

In a case where water flows through the supply tubing and the cooking water tubing simultaneously, the second three-way valve may connect the supply tubing with the second tubing, and the cooking water valve may be opened.

When the shared water purification system operates in a sterilization mode, water flowing into the first tubing may pass through the bypass tubing while being heated in the heater, and then flow through the supply tubing and the cooking water tubing at different times, thereby sterilizing each tubing sequentially.

In a case where water flows through the supply tubing and the cooking water tubing at different times and a sterilization of the supply tubing is in progress, the second three-way valve may connect the supply tubing with the second tubing, and the cooking water valve may be closed.

In a case where water flows through the supply tubing and the cooking water tubing at different times and a sterilization of the cooking water tubing is in progress, the cooking water valve may be opened, and the second three-way valve may be closed.

The supply tubing may be provided in a plural number so that they are connected to a plurality of home appliances, respectively, and the second three-way valve and the second tubing may be provided in a plural number so as to correspond to each of the plurality of supply tubings.

When the shared water purification system operates in a sterilization mode, water flowing into the first tubing may pass through the bypass tubing while being heated in the heater, and then flow through the plurality of supply tubings and the cooking water tubing simultaneously.

When the shared water purification system operates in a sterilization mode, water flowing into the first tubing may pass through the bypass tubing while being heated in the heater, and then flow through the plurality of supply tubings and the cooking water tubing at different times, thereby sterilizing each tubing sequentially.

The shared water purification system may include a washing water tubing branched from the first tubing, and allowing water which has passed through the filter to flow therethrough, a washing water valve disposed in the washing water tubing to control a flow of washing water, and an electrolyzed water module disposed in the washing water tubing to produce electrolyzed water with a use of water flowing through the washing water tubing.

A shared water purification system according to another embodiment may include a first tubing through which water flowing in from an outside flows, a first three-way valve disposed in the first tubing, a bypass tubing connected at one end to the first three-way valve and at another end to the first tubing, a heater disposed in the bypass tubing, a filter disposed at a location in the first tubing past a water output point of the bypass tubing in a flow direction of water, a supply tubing connected to the first tubing and supplying water which has passed through the filter to a home appliance, a cooking water tubing connected to the first tubing and supplying water which has passed through the filter as cooking water, a cooking water valve disposed in the cooking water tubing and opening or closing the cooking water tubing, a second three-way valve disposed in the supply tubing, a second tubing coupled at one end to the second three-way valve, and a drain tubing coupled with the second tubing and discharging water flowing through the second tubing to an outside.

When the shared water purification system operates in a sterilization mode, water which has flowed into the supply tubing may flow sequentially through the second tubing and the drain tubing, and then be discharged to an outside.

When the shared water purification system operates in a sterilization mode, water flowing into the first tubing may pass through the bypass tubing while being heated in the heater, and then flow through the supply tubing and the cooking water tubing simultaneously, thereby sterilizing the supply tubing and the cooking water tubing simultaneously.

When the shared water purification system operates in a sterilization mode, water flowing into the first tubing may pass through the bypass tubing while being heated in the heater, and then flow through the supply tubing and the cooking water tubing at different times, thereby sterilizing each tubing sequentially.

### Advantageous Effects

In the shared water purification system according to the present invention, the complex tubings provided in the shared water purification system can be easily sterilized using simple devices such as the heater and the three-way valve. Consequently, it is possible to make simpler the structure of the shared water purification system, thus saving manufacturing costs and reducing the overall size of the shared water purification system, while at the same time effectively sterilizing the inside of the shared water purification system.

In the shared water purification system according to the present invention, the plurality of supply tubings and the cooking water tubing can be sterilized simultaneously using the hot water. Consequently, it is possible to shorten the time required to sterilize the plurality of tubings provided in the shared water purification system.

In the shared water purification system according to the present invention, the plurality of supply tubings and the cooking water tubings can be sterilized individually and sequentially at different times using the hot water. Consequently, it is possible to sterilize each tubing provided in the shared water purification system sufficiently and thoroughly.

In addition to the effects described above, specific effects of the present invention will be described below together with specific matters for practicing the invention.

### DESCRIPTION OF DRAWINGS

FIG. 1 is a schematic diagram showing a shared water purification system according to one embodiment.

FIG. 2 is a drawing for explaining the flow of hot water in a shared water purification system when simultaneously sterilizing a plurality of tubings connected to home appliances and a faucet.

FIG. 3 is a drawing for explaining the flow of hot water in the shared water purification system when sterilizing the tubing connected to a dishwasher.

FIG. 4 is a drawing for explaining the flow of hot water in the shared water purification system when sterilizing the tubing connected to a water purifier.

FIG. 5 is a drawing for explaining the flow of hot water in the shared water purification system when sterilizing the tubing connected to a refrigerator.

FIG. 6 is a drawing for explaining the flow of hot water in the shared water purification system when sterilizing the tubing connected to the faucet.

### BEST MODE

The purposes, features and advantages described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference symbols are used to refer to like or similar components.

Although the terms “first”, “second”, and so on are used to describe various components, these components are not limited by these terms. These terms are merely used to distinguish one component from another component, and unless specifically stated to the contrary, it should be understood that a first component may also be a second component.

Throughout the specification, unless specifically stated to the contrary, each element may be singular or plural.

As used herein, singular expressions include plural expressions unless the context clearly dictates otherwise. Herein, the terms “be comprised of” or “comprise” should not be construed to necessarily include all of the various components or various steps described in the specification, and should be construed to mean that some of the components or some of the steps may not be included, or that additional components or steps may be included.

Throughout the present document, “A and/or B” means A, B, or A and B, unless otherwise specified, and “C to D” means equal to or greater than C and equal to or smaller than D unless otherwise specified.

A shared water purification system according to an embodiment may, for example, be provided so as to be installed in a built-in manner in a sink cabinet provided in a kitchen in a house. The shared water purification system according to an embodiment may operate in a usage mode or a sterilization mode.

In the usage mode, the shared water purification system may produce drinking water for drinking by users, cooking water for food preparation, and washing water used for cleaning. In the sterilization mode, the shared water purification system may sterilize each tubing and a filter 140 which build up the shared water purification system.

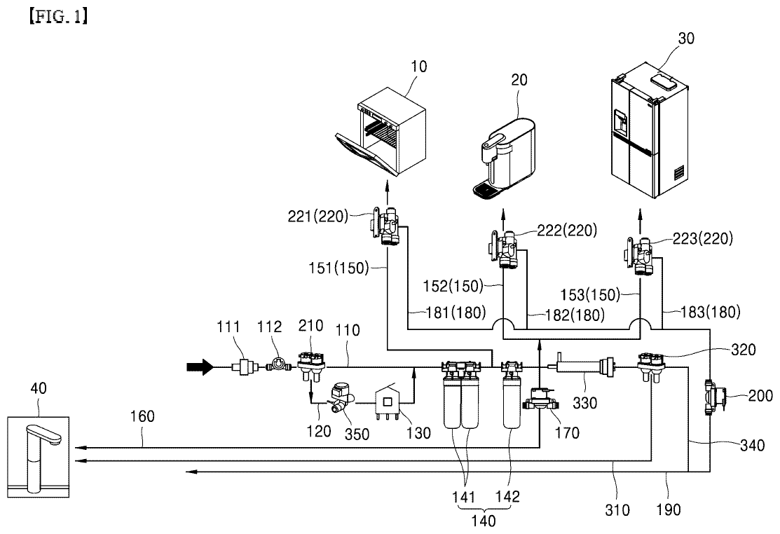

FIG. 1 is a schematic diagram showing a shared water purification system according to one embodiment. The shared water purification system may be connected through tubings with a plurality of home appliances which receive water drinkable for users, and with a faucet 40 through which cooking water and washing water are discharged.

The home appliances may be, for example, a dishwasher 10, a water purifier 20, a refrigerator 30, and the like. Of course, if there are other appliances requiring a supply of filtered drinking water, they may also be connected with the shared water purification system.

The water used for washing in the dishwasher 10 may be water drinkable for the user. For hygiene and user's health, drinking water is used as washing water.

The water purifier 20 may discharge drinking water. In the water purifier 20, there may be provided a device heating or cooling water. However, since water which has been filtered in the shared water purification system is supplied to the water purifier 20, a separate filtering device for filtering water may not be provided inside the water purifier 20.

The refrigerator 30 may be provided with a dispenser from which drinking water is discharged. The faucet 40 may discharge filtered cooking water and washing water.

Hereinafter, the shared water purification system will be described while using the dishwasher 10, the water purifier 20, and the refrigerator 30 as examples of home appliances that discharge drinking water drinkable for the user. Other home appliances that discharge drinking water include a coffee machine and a humidifier which uses drinking water.

The shared water purification system may include a first tubing 110, a first three-way valve 210, a bypass tubing 120, a heater 130, a filter 140, and a supply tubing 150.

Through the first tubing 110 a water flowing in from the outside may flow. The first tubing 110 may be connected to a water pipe on one side, and to a cooking water tubing 160 on the other side. In the first tubing 110 a pressure reducing valve 111 and a flow sensor 112 may be disposed.

The pressure reducing valve 111 can reduce the pressure of raw water flowing in from the water pipe so that the water flowing through the shared water purification system can have a water pressure suitable for the water purifier 20. Further, the pressure reducing valve 111 can stabilize the flow of water in the first tubing 110. The flow sensor 112 may measure the flow rate of water flowing through the first tubing 110.

The first three-way valve 210 may be disposed in the first tubing 110 to control the flow direction of water flowing through the first tubing 110. The three-way valve described in the specification may be coupled with three tubings, and may connect any two of the three tubings with each other or close all three tubings.

The first three-way valve 210 may be disposed at the first tubing 110 and the inlet side branch point of the bypass tubing 120. Two of the three inlets or may be referred to as outlets of the first three-way valve 210 may be connected to the first tubing 110, and the remaining one may be connected to the bypass tubing 120. The first three-way valve 210 may connect between the first tubing 110, or connect the first tubing 110 with the bypass tubing 120 according to the selection.

The bypass tubing 120 may be connected at one end to the first three-way valve 210 and at the other end to the first tubing 110. That is, the inlet side end of the bypass tubing 120 may be connected to the first three-way valve 210, and the outlet side end thereof may be connected to the first tubing 110.

The heater 130 may be disposed in the bypass tubing 120, and may operate to heat water flowing into the bypass tubing 120 to produce hot water for sterilization when the shared water purification system operates in a sterilization mode.

The shared water purification system may include a flow control valve 350 provided in the bypass tubing 120. The flow control valve 350 may be disposed at a point before the inlet of the heater 130 in the flow direction of water to control the flow rate of water flowing into the heater 130.

The filter 140 may be disposed at a location past the water output point of the bypass tubing 120 in the flow direction of water in the first tubing 110. Thereby, hot water produced by the heater 130 can pass through the filter 140 to sterilize the inside of the filter 140.

The filter 140 may be provided in a plural number, and include a first part 141 and a second part 142. The first part 141 may be disposed in the front side of the second part 142 in the flow direction of water. The water which has been filtered in the first part 141 may be drinkable for users and, however, not be drunk usually by them, and may be used for dishwashing.

The first part 141 may be provided with, for example, a carbon block filter, and may be provided in a plural number. Water to be used in the dishwasher 10 may pass through the first part 141 and flow into the dishwasher 10 without flowing into the second part 142.

Water which has passed through the first part 141 may also pass through the second part 142 while being filtered so that it can become drinking water for the user. The second part 142 may be provided with an UF (hollow fiber membrane) filter which allows minerals necessary for human beings to pass through itself and filters out substances harmful to human beings.

The supply tubing 150 may be connected to the first tubing 110, and supply water which has passed through the filter 140 to the home appliance. One end of the supply tubing 150 may be connected to the first tubing 110, and the other end thereof may be connected to each home appliance.

The supply tubing 150 may be provided in a plural number so that they can be connected to the plurality of home appliances, respectively. The supply tubing 150 may be provided in a plural number so as to be individually and in parallel connected to each home appliance, and may include a first sub-tubing 151, a second sub-tubing 152, and a third sub-tubing 153.

The first sub-tubing 151 may connect the first tubing 110 with the dishwasher 10. Water to flow into the dishwasher 10 may pass through the first part 141 and directly flow into the dishwasher 10. Therefore, the first sub-tubing 151 may be branched from the first tubing 110 at a point between the first part 141 and the second part 142.

The second sub-tubing 152 may connect the first tubing 110 with the water purifier 20, and the third sub-tubing 153 may connect the first tubing 110 with the refrigerator 30. Since the second sub-tubing 152 and the third sub-tubing 153 are for the flow of drinking water through themselves, they may be branched from the first tubing 110 at a point past the second part 142 in the flow direction of water. The second sub-tubing 152 and the third sub-tubing 153 may have a common tubing in a point portion where they are branched from the first tubing 110, and may be branched from this common tubing.

The shared water purification system may include the cooking water tubing 160 that is connected to the first tubing 110 and supplies water which has passed through the filter 140 as cooking water. The cooking water tubing 160 may be connected with the first tubing 110 at a point past the second part 142. One end of the cooking water tubing 160 may be connected with the first tubing 110 and the other end thereof may be connected with the faucet 40.

Through the cooking water tubing 160 the cooking water used to prepare food may flow. The cooking water is a purified water which has passed though the filter 140. In a usage mode, water may be filtered by passing through the filter 140 to become cooking water, and the cooking water may flow through the cooking water tubing 160 and be discharged through the faucet 40.

The shared water purification system may include a cooking water valve 170 disposed in the cooking water tubing 160 and opening or closing the cooking water tubing 160. When the user uses the cooking water, the cooking water valve 170 may be opened, so that the cooking water which has passed through the filter 140 can flow through the cooking water tubing 160 and be discharged through the faucet 40.

The shared water purification system may include a second three-way valve 220, a second tubing 180, and a drain tubing 190. The second three-way valve 220 and the second tubing 180 may be provided in a plural number so as to correspond to each of the plurality of supply tubings 150.

The second three-way valve 220 may be disposed in the supply tubing 150 to control the flow direction of water flowing through the supply tubing 150. Two of the three inlets or may be referred to as outlets of the second three-way valve 220 may be connected to the second tubing 180, and the remaining one may be connected to the drain tubing 190. The second three-way valve 220 may connect between the second tubing 180, or connect the second tubing 180 with the drain tubing 190 according to the selection.

The second three-way valve 220 may be provided in the same number as the supply tubings 150 connected to the home appliances, respectively, and may be disposed in parallel with each other. The second three-way valve 220 may include a first sub-valve 221, a second sub-valve 222, and a third sub-valve 223.

The first sub-valve 221 may be disposed in the first sub-tubing 151 connected to the dishwasher 10, and be connected with the second-first tubing 181. The second sub-valve 222 may be disposed in the second sub-tubing 152 connected to the water purifier 20, and be connected with the second-second tubing 182. The third sub-valve 223 may be disposed in the third sub-tubing 153 connected to the refrigerator 30, and be connected with the second-third tubing 183.

The second tubing 180 may be connected at one end to the second three-way valve 220 and at the other end to the drain tubing 190. When the shared water purification system operates in a sterilization mode, the second tubing 180 can serve to send hot water for sterilization to the drain tubing 190.

The second tubing 180 may be provided in the same number as the supply tubings 150 connected to the home appliances, respectively, and may be disposed in parallel with each other. The second tubing 180 may include the second-first tubing 181, the second-second tubing 182, and the second-third tubing 183.

The second-first tubing 181 may be connected to the first sub-valve 221 which controls the flow of water flowing into the dishwasher 10. The second-second tubing 182 may be connected to the second sub-valve 222 which controls the flow of water flowing into the water purifier 20. The second-third tubing 183 may be connected to the third sub-valve 223 which controls the flow of water flowing into the refrigerator 30.

The drain tubing 190 may be connected with the second tubing 180 to discharge water flowing through the second tubing 180 to the outside. When the shared water purification system operates in the sterilization mode, the sterilization hot water flowing through the second tubing 180 may be discharged to the outside through the drain tubing 190. In the drain tubing 190 a drain valve 200 may be disposed which controls the flow of water being drained.

The shared water purification system may include a washing water tubing 310, a washing water valve 320, and an electrolyzed water module 330. The washing water tubing 310 may be branched from the first tubing 110, allowing the water which has passed through the filter 140 to flow therethrough.

The washing water tubing 310 is a tubing through which washing water flows. The outlet of the washing water tubing 310 may be connected to the faucet 40, and the washing water may be discharged through the faucet 40. Washing water is meant to contain a sterilizing substance, and in the shared water purification system purifier of the embodiment, electrolyzed water containing a sterilizing substance generated in the process of electrolyzing water may be used as washing water.

The washing water valve 320 may be disposed in the washing water tubing 310 to control the flow of washing water. The washing water valve 320 may be provided as a three-way valve, and one of the three inlets may be connected to the drain tubing 190. The shared water purification system may include a fourth sub-tubing 340 connecting between the drain tubing 190 and the washing water valve 320.

The electrolyzed water module 330 may be disposed in the washing water tubing 310 to produce electrolyzed water with the use of water flowing through the washing water tubing 310. The electrolyzed water module 330 may produce electrolyzed water containing a sterilizing substance by electrolyzing water that has passed through the filter 140.

In the shared water purification system of the embodiment, the washing water tubing 310 may not be sterilized with hot water. Since the washing water tubing 310 allows electrolyzed water containing a sterilizing substance to flow therethrough, it is sufficiently sterilized by the electrolyzed water, so there is no need to sterilize it separately using hot water.

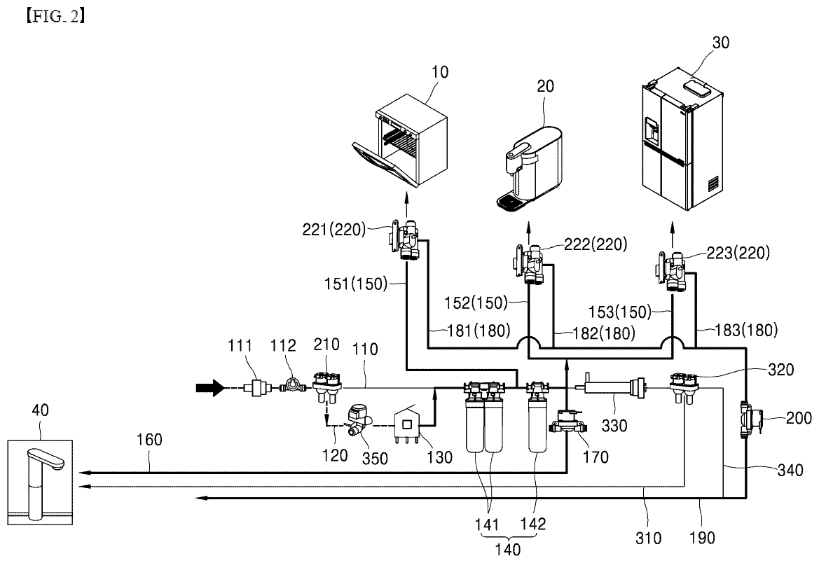

Hereinafter, the process of sterilizing the tubings of the shared water purification system will be specifically described with reference to the drawings. FIG. 2 is a drawing for explaining the flow of hot water in a shared water purification system when simultaneously sterilizing a plurality of tubings connected to the home appliances and the faucet 40.

In FIG. 2 and the following drawings, the thick hidden lines represent the sections along which unheated water flows, and the thick solid lines represent the sections along which heated hot water flows to sterilize the tubings. Additionally, FIG. 2 and the following drawings show the flows of water when the shared water purification system operates in the sterilization mode.

When the shared water purification system operates in the sterilization mode, water flowing into the first tubing 110 may pass through the bypass tubing 120 while being heated in the heater 130, and then flow through the supply tubing 150.

At this time, the first three-way valve 210 may operate to connect the first tubing 110 and the bypass tubing 120 to each other, and water flowing into the bypass tubing 120 may be heated in the heater 130 and then flowed again into the first tubing 110.

When the shared water purification system operates in the sterilization mode, water which has flowed into the supply tubing 150 may flow sequentially through the second tubing 180 and the drain tubing 190, and be discharged to the outside. At this time, the second three-way valve 220 may operate to connect the supply tubing 150 and the second tubing 180 with each other. Additionally, the drain valve 200 may be opened, so that hot water for sterilization can flow through the drain tubing 190 and be discharged to the outside.

When the shared water purification system operates in the sterilization mode, water flowing into the first tubing 110 may pass through the bypass tubing 120 while being heated in the heater 130, and then flow through the cooking water tubing 160 while sterilizing the cooking water tubing 160.

That is, hot water heated by the heater 130 and then flowed back into the first tubing 110 may flow through the cooking water tubing 160 to sterilize the cooking water tubing 160, and then may be discharged to the outside through the faucet 40.

The embodiment illustrated in FIG. 2 illustrates a method of sterilizing the cooking water tubing 160 and a plurality of supply tubings 150 by causing the hot water to simultaneously flow through these tubings.

In this regard, when the shared water purification system operates in the sterilization mode, water flowing into the first tubing 110 may pass through the bypass tubing 120 while being heated in the heater 130, and then flow through the supply tubing 150 and the cooking water tubing 160 simultaneously.

At this time, the supply tubing 150 may be provided in a plural number, and the water which has been heated in the heater 130 may flow through the plurality of supply tubings 150 simultaneously, so that all the plurality of supply tubings 150 can be sterilized simultaneously.

The hot water which has been heated in the heater 130 may simultaneously flow through a plurality of supply tubings 150 connected to the first tubing 110 to sterilize the supply tubings 150. That is, the hot water may simultaneously flow through the first sub-tubing 151, the second sub-tubing 152, and the third sub-tubing 153, which are branched from the first tubing 110, to sterilize these tubings.

In the case where water flows through the supply tubing 150 and the cooking water tubing 160 simultaneously, the second three-way valve 220 may connect the supply tubing 150 with the second tubing 180, and the cooking water valve 170 may be opened.

Specifically, the first sub-valve 221 may connect the first sub-tubing 151 with the second-first tubing 181; the second sub-valve 222 may connect the second sub-tubing 152 with the second-second tubing 182; and the third sub-valve 223 may connect the third sub-tubing 153 with the second-third tubing 183. At this time, the cooking water valve 170 may be opened.

Meanwhile, during the sterilization process, the hot water for sterilization flows through the filter 140 including the first part 141 and the second part 142 disposed in the first tubing 110, so that the inside of the filter 140 can also be sterilized by the hot water.

While the sterilization mode is in progress, the washing water valve 320 may be closed to prevent the hot water from being discharged to the outside through the washing water tubing 310.

In the case where hot water for sterilization flows through a plurality of supply tubings 150 and the cooking water tubing 160 simultaneously to sterilize these tubings simultaneously, there is an advantage of shortening the sterilization time.

However, when sterilizing the tubings simultaneously, the hot water for sterilization flowing through all the tubings may not be distributed evenly to the tubings. In this case, there may be no or little flowing hot water for sterilization in some tubings, so that it may not be possible to accomplish sufficient sterilization.

Therefore, although the sterilization time may be somewhat increased, the tubings may be sterilized individually and sequentially at different times so that every tubing can be sterilized sufficiently. Hereinafter, with reference to the drawings, there will be described sterilization processes in which all the tubings are sterilized individually and sequentially at different times.

The user may select whether to sterilize the tubings simultaneously, or individually and sequentially at different times, and a controller provided in the shared water purification system may implement a mode for sterilizing the tubings simultaneously or at different times according to the user selection.

When the shared water purification system operates in the sterilization mode, water flowing into the first tubing 110 may pass through the bypass tubing 120 while being heated in the heater 130, and then flow through the supply tubing 150 and the cooking water tubing 160 at different times, thereby sterilizing each tubing sequentially.

That is, the hot water may sterilize any one supply tubing 150 of the plurality of supply tubings 150 or only the cooking water tubing 160, and then sequentially sterilize the other tubings to complete the sterilization procedures for all the tubings. At this time, there is no particular order of priority with respect to the plurality of tubings, but the order in which the tubings are sterilized may be set in advance.

When the shared water purification system operates in the sterilization mode, water flowing into the first tubing 110 may pass through the bypass tubing 120 while being heated in the heater 130, and then flow through the supply tubing 150 and the cooking water tubing 160 at different times, thereby sterilizing each tubing sequentially.

The plurality of supply tubings 150 may also be sterilized one by one by the hot water, so that all the plurality of supply tubings 150 can be sterilized.

Hot water may sterilize all the tubings in a way where it sterilizes a specific tubing by flowing through it, and then, after this sterilization has been completed, sterilizes the next tubing by flowing through it.

In the case where water flows through the supply tubing 150 and the cooking water tubing 160 at different times and the sterilization of the supply tubing 150 is in progress, the second three-way valve 220 may connect the supply tubing 150 with the second tubing 180, and the cooking water valve 170 may be closed.

Since the cooking water valve 170 is closed, so that the hot water for sterilization does not flow through the cooking water tubing 160 while the hot water flows only through the supply tubing 150, only the supply tubing 150 can be sterilized.

Even if the cooking water valve 170 is closed, a portion of the cooking water tubing 160 may be filled with hot water, and however, the filled hot water not flowing anywhere may be cooled down, thus being likely to produce no significant sterilization effect with respect to the cooking water tubing 160. In the embodiment, the cooking water tubing 160 may be sterilized by causing the hot water to continuously flow into the cooking water tubing 160.

Conversely, in the case where water flows through the supply tubing 150 and the cooking water tubing 160 at different times and the sterilization of the cooking water tubing 160 is in progress, the cooking water valve 170 may be opened, and the second three-way valve 220 may be closed.

Since the second three-way valve 220 is closed, so that the hot water for sterilization does not flow through the supply tubing 150 and the second tubing 180 while the hot water flows only to the cooking water tubing 160, only the cooking water tubing 160 can be sterilized.

Likewise, even if the second three-way valve 220 is closed, a portion of the supply tubing 150 may be filled with hot water, and however, the filled hot water not flowing anywhere may be cooled down, thus being likely to produce no significant sterilization effect with respect to the supply tubing 150. In the embodiment, the supply tubing 150 can be sterilized by causing the hot water to continuously flow into the supply tubing 150.

Meanwhile, while the sterilization mode is in progress, the washing water valve 320 may be closed to prevent the hot water from being discharged to the outside through the washing water tubing 310.

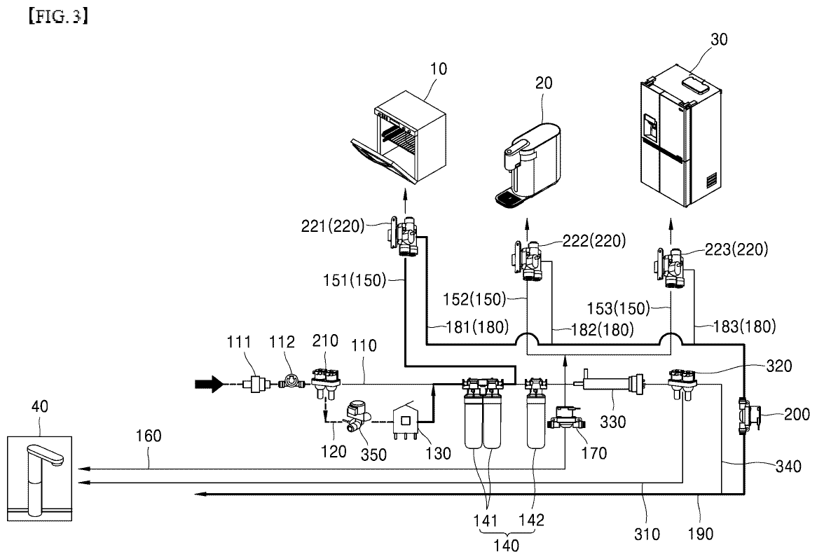

FIG. 3 is a drawing for explaining the flow of hot water in the shared water purification system when sterilizing the tubing connected to the dishwasher 10. In the embodiment shown in FIG. 3, the first sub-tubing 151 connected to the dishwasher 10 may be sterilized with hot water.

Hot water produced from the heater 130 may pass through the bypass tubing 120 and the first tubing 110, and then flow through the first sub-tubing 151. At this time, the first sub-valve 221 may connect the first sub-tubing 151 with the second-first tubing 181. The second sub-valve 222, the third sub-valve 223, and the cooking water valve 170 may be closed.

Thereby, the hot water can sterilize the first sub-tubing 151 while passing through the first sub-tubing 151, and be discharged to the outside through the second-first tubing 181 and the drain tubing 190.

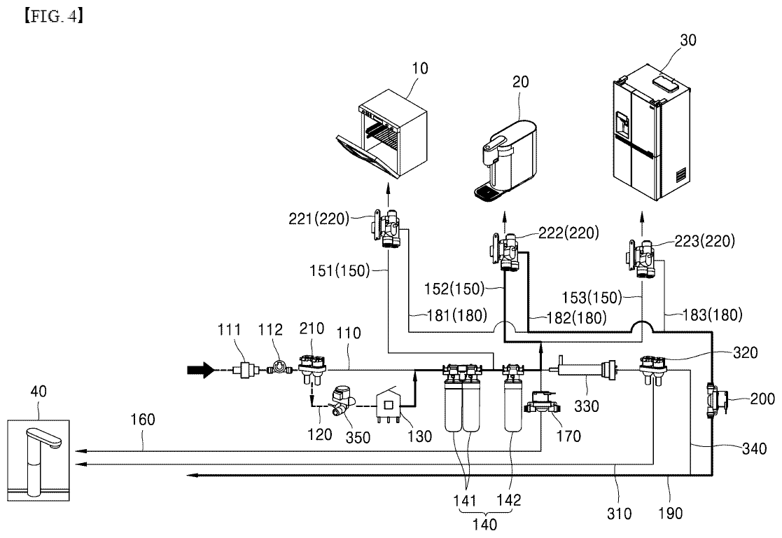

FIG. 4 is a drawing for explaining the flow of hot water in the shared water purification system when sterilizing the tubing connected to the water purifier 20. In the embodiment shown in FIG. 4, the second sub-tubing 152 connected to the water purifier 20 may be sterilized with hot water.

Hot water produced from the heater 130 may pass through the bypass tubing 120 and the first tubing 110, and then flow through the second sub-tubing 152. At this time, the second sub-valve 222 may connect the second sub-tubing 152 with the second-second tubing 182. The first sub-valve 221, the third sub-valve 223, and the cooking water valve 170 may be closed.

Thereby, the hot water can sterilize the second sub-tubing 152 while passing through the second sub-tubing 152, and be discharged to the outside through the second-second tubing 182 and the drain tubing 190.

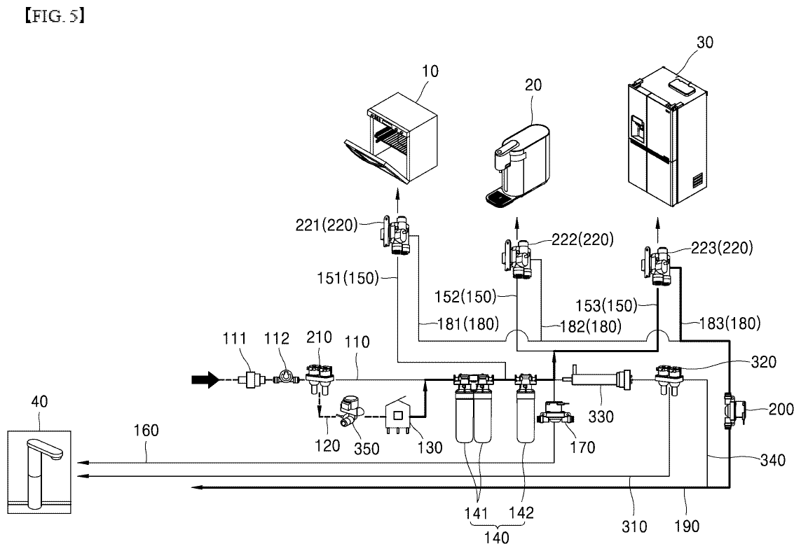

FIG. 5 is a drawing for explaining the flow of hot water in the shared water purification system when sterilizing the tubing connected to the refrigerator 30. In the embodiment shown in FIG. 5, the third sub-tubing 153 connected to the refrigerator 30 may be sterilized with hot water.

Hot water produced from the heater 130 may pass through the bypass tubing 120 and the first tubing 110, and then flow through the third sub-tubing 153. At this time, the third sub-valve 223 may connect the third sub-tubing 153 with the second-third tubing 183. The first sub-valve 221, the second sub-valve 222, and the cooking water valve 170 may be closed.

Thereby, the hot water can sterilize the third sub-tubing 153 while passing through the third sub-tubing 153, and be discharged to the outside through the second-third tubing 183 and the drain tubing 190.

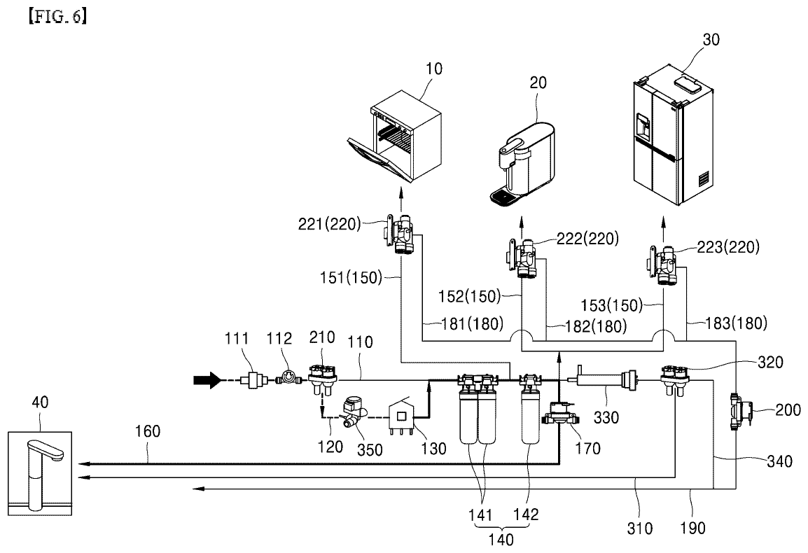

FIG. 6 is a drawing for explaining the flow of hot water in the shared water purification system when sterilizing the tubing connected to the faucet 40. In the embodiment shown in FIG. 6, the cooking water tubing 160 connected to the faucet 40 may be sterilized with hot water.

The hot water produced from the heater 130 may pass through the bypass tubing 120 and the first tubing 110, and then flow through the cooking water tubing 160. At this time, the cooking water valve 170 may be opened. The first sub-valve 221, the second sub-valve 222, and the third sub-valve 223 may be closed.

Thereby, the hot water can passes through the cooking water tubing 160 while sterilizing the cooking water tubing 160, and can be discharged to the outside through the faucet 40 connected to the cooking water tubing 160.

In the embodiment, the complex tubings provided in the shared water purification system can be easily sterilized using simple devices such as the heater 130 and the three-way valve. Consequently, it is possible to make simpler the structure of the shared water purification system, thus saving manufacturing costs and reducing the overall size of the shared water purification system, while at the same time effectively sterilizing the inside of the shared water purification system.

In the embodiment, the plurality of supply tubings 150 and the cooking water tubing 160 can be sterilized simultaneously using the hot water. Consequently, it is possible to shorten the time required to sterilize the plurality of tubings provided in the shared water purification system.

In the embodiment, the plurality of supply tubings 150 and the cooking water tubings can be sterilized individually and sequentially at different times using the hot water. Consequently, it is possible to sterilize each tubing provided in the shared water purification system sufficiently and thoroughly.

The shared water purification system according to the embodiment can operate in the usage mode or the sterilization mode. Hereinabove, the process of the shared water purification system operating in the sterilization mode has been described.

The tubing sterilization operation of the shared water purification system according to the embodiment described above with reference to FIGS. 2 to 6 may be performed, for example, by the controller provided in the shared water purification system receiving a user's sterilization operation execution command and controlling the operation of the heater 130, various valves, and the like according to it.

Alternatively, the tubing sterilization operation of the shared water purification system may be performed by the controller at a preset time point. In this regard, the time when the tubing sterilization is performed may be selected from among, for example, late night time bands when the frequency of users using the water purifier 20 is very low.

Although the present invention has been described with reference to the illustrative drawings as the above, the present invention is not limited to the embodiments and drawings disclosed in this specification, and it is obvious that various modifications can be made by those skilled in the art without departing from the scope of the technical idea of the present invention. Additionally, even if the effects related to the configuration of the present invention were not explicitly described while explaining the embodiments of the present invention, it is obvious that the effects predictable from the configuration should also be acknowledged.

1. A shared water purification system comprising:
a first tubing through which water flows from outside;
a first valve disposed in the first tubing;
a bypass tubing connected at one end to the first valve and at another end to the first tubing;
a heater disposed in the bypass tubing;
a filter disposed at a location in the first tubing past a water output point of the bypass tubing in a flow direction of water; and
a supply tubing connected to the first tubing and that supplies water which has passed through the filter to a home appliance,
wherein when the shared water purification system operates in a sterilization mode, water from the first tubing passes through the bypass tubing and is heated in the heater, and then flows through the supply tubing.

2. The shared water purification system of claim 1, comprising:
a filtered water tubing connected to the first tubing and that supplies water which has passed through the filter as filtered water,
wherein when the shared water purification system operates in the sterilization mode, water after passing through the bypass tubing and being heated in the heater, then flows through the filtered water tubing.

3. The shared water purification system of claim 2, comprising:
a filtered water valve disposed in the filtered water tubing and that opens and closes the filtered water tubing.

4. The shared water purification system of claim 3, comprising:
a second valve disposed in the supply tubing;
a second tubing coupled at one end to the second valve; and
a drain tubing connected to the second tubing and that discharges water flowing from the second tubing to an outside.

5. The shared water purification system of claim 4, wherein when the shared water purification system operates in the sterilization mode, water from the supply tubing flows sequentially through the second tubing and the drain tubing, and then is discharged to the outside.

6. The shared water purification system of claim 4, wherein when the shared water purification system operates in the sterilization mode, water, after passing through the bypass tubing and being heated in the heater, flows through the supply tubing and the filtered water tubing simultaneously.

7. The shared water purification system of claim 6, wherein in a case where water is heated in the heater and then flows through the supply tubing and the filtered water tubing simultaneously, the second valve connects the supply tubing with the second tubing, and the filtered water valve is opened.

8. The shared water purification system of claim 4, wherein when the shared water purification system operates in the sterilization mode, water after passing through the bypass tubing and being heated in the heater, flows through the supply tubing and the filtered water tubing at different times, such that the supply tubing and the filtered water tubing are sterilized sequentially.

9. The shared water purification system of claim 8, wherein in a case where the sterilization mode includes heated water flowing through the supply tubing and not through the filtered water tubing, the second valve connects the supply tubing with the second tubing, and the filtered water valve is closed.

10. The shared water purification system of claim 9, wherein in a case where the sterilization mode includes heated water not flowing through the supply tubing and flowing through the filtered water tubing, the filtered water valve is opened, and the second valve is closed.

11. The shared water purification system of claim 4, wherein the supply tubing includes a plurality of supply tubings that are connected to a plurality of home appliances, respectively, and
wherein the second valves includes a plurality of second valves, and the second tubing includes a plurality of second tubings so as to correspond to the plurality of supply tubings.

12. The shared water purification system of claim 11, wherein when the shared water purification system operates in the sterilization mode, water after passing through the bypass tubing and being heated in the heater, then flows through the plurality of supply tubings and the filtered water tubing simultaneously.

13. The shared water purification system of claim 11, wherein when the shared water purification system operates in the sterilization mode, water after passing through the bypass tubing and being heated in the heater, then flows through the plurality of supply tubings and the filtered water tubing at different times, such that the plurality of supply tubings and the filter water tubing are sequentially sterilized.

14. The shared water purification system of claim 1, comprising:
an electrolyzed water tubing branched from the first tubing to transport water which has passed through the filter;
an electrolyzed water valve disposed in the electrolyzed water tubing to control a flow of water along the electrolyzed water tubing; and
an electrolyzed water module disposed in the electrolyzed water tubing to produce electrolyzed water with water flowing through the electrolyzed water tubing.

15. A shared water purification system comprising:
a first tubing through which water flows in from outside;
a first valve disposed in the first tubing;
a bypass tubing connected at one end to the first valve and at another end to the first tubing;
a heater disposed in the bypass tubing;
a filter disposed in the first tubing past and past the other end of the bypass tubing in a flow direction of water;
a supply tubing connected to the first tubing and that supplies water which has passed through the filter to a home appliance;
a filtered water tubing connected to the first tubing and that supplies water which has passed through the filter as filtered water;
a filtered water valve disposed in the filtered water tubing and that opens and closes filtered water tubing;
a second valve disposed in the supply tubing;
a second tubing coupled to the second valve; and
a drain tubing coupled with the second tubing and that discharges water from the second tubing to an outside.

16. The shared water purification system of claim 15, wherein when the shared water purification system operates in a sterilization mode, water that flows through the supply tubing and is heated by the heater flows sequentially through the second tubing and the drain tubing, and then is discharged to an outside.

17. The shared water purification system of claim 15, wherein when the shared water purification system operates in a sterilization mode, water that flows through the bypass tubing and is heated in the heater, then flows through the supply tubing and the filtered water tubing simultaneously, such that the supply tubing and the filtered water tubing are sterilized simultaneously.

18. The shared water purification system of claim 15, wherein when the shared water purification system operates in a sterilization mode, water flowing that flows through the bypass tubing and is heated in the heater, then flows through the supply tubing and the filtered water tubing at different times, thereby sterilizing each of the supply tubing and the filter water tubing sequentially.

19. The shared water purification system of claim 11, wherein when the shared water purification system operates in the sterilization mode, water after passing through the bypass tubing and being heated in the heater, flows sequentially through the plurality of supply tubings.

20. The shared water purification system of claim 1, wherein:
the home appliance includes a first home appliance and a second home appliance,
the filter includes a first filter and second filter that are provided sequentially on the first tubing such that the second filter receives water filtered by the first filter,
the supply tubing includes a first supply tubing and a second tubing that supply water respectively, to the first home appliance and the second home appliance, and
the first supply tubing is connected to the first tubing between the first filter and second filter such that the first home appliance receives water that is filtered by the first filter and not by the second filter, and the second supply tubing is connected to the first tubing downstream of the second filter such that the second home appliance receives water that is filtered by both the first filter and the second filter.
